(19) United States
(12) Patent Application Publication
(10) Pub. No.: US 2016/0034596 A1
(43) Pub. Date: Feb. 4, 2016

(54) METHOD AND SYSTEM FOR BROWSING VIRTUAL OBJECT

(71) Applicant: Korea Advanced Institute of Science and Technology, Daejeon (KR)

(72) Inventors: Jun Kyun Choi, Daejeon (KR); Jin Hong Yang, Daejeon (KR); Hyo Jin Park, Daejeon (KR)

(73) Assignee: Korea Advanced Institute of Science and Technology, Daejeon (KR)

(21) Appl. No.: 14/621,343

(22) Filed: Feb. 12, 2015

(30) Foreign Application Priority Data
Aug. 1, 2014 (KR) 10-2014-0098992
Oct. 24, 2014 (KR) 10-2014-0145301

(51) Int. Cl. G06F 17/30; G06F 3/0482; H04L 29/08

(52) U.S. Cl. CPC G06F 17/30914; H04L 67/10; G06F 3/0482

(57) ABSTRACT

Disclosed is a method and system for browsing a virtual object. A virtual object browsing method includes acquiring identification information of a captured object from the object, acquiring information about a service provider of a virtual object mapped to the identification information, and acquiring related information of the object from the corresponding service provider based on the information about the service provider.

### CROSS-REFERENCE TO RELATED APPLICATION

This application claims the priority benefit of Korean Patent Application No. 10-2014-0098992, filed on Aug. 1, 2014, and Korean Patent Application No. 10-2014-0145301, filed on Oct. 24, 2014, in the Korean Intellectual Property Office, the disclosure of which is incorporated herein by reference.

### BACKGROUND

1. Field of the Invention

Embodiments of the present invention relate to a technology for browsing a virtual object in a next generation web environment.

2. Description of the Related Art

The Internet of Things (IoT) indicates the concept that mutual communication is enabled by connecting things over a network. Further, the Internet of Everything (IoE) indicates the expanded concept of the IoT and represents that all the things are communicable. For example, if a television (TV) is communicable, the TV may be regarded as the IoT. If all the parts included in the TV are communicable, the TV may be regarded as the IoE.

All the objects systematically recognizable in IoT and IoE environments may be classified as things or objects. A thing, such as a sensor, including near field and far field communication functions and capable of generating and utilizing data or a person may be included therein.

As an example of a technology for providing an IoT service, Korean Patent Laid-Open Publication No. 10-2014-0008667, published on Jan. 22, 2014, titled “method for providing an IoT service” discloses a technology for providing an IoT service using a device (D)-platform, a planet (P)-platform, a mash-up (M)-platform, and a store (S)-platform.

The development in an Internet environment has brought the era of virtual object browsing through the evolvement from the era of webpage browsing to IoT to IoE environments.

An existing web may be a cyber world based on a connection between webpages. Here, data or information structured in a form of a webpage may be centric.

In the IoT through IoE environments, a connection to information and an intangible service connected to peripheral information such as a change in a device environment and a virtual object is required. Thus, using a text query as used in the existing web is difficult and a browsing technology linked with a device is required to browse a virtual object.

### SUMMARY

An aspect of the present invention provides a method and system for discovering related information based on a user's intent in a next generation web environment in which real-world information is connected to a virtual object.

An aspect of the present invention also provides a browsing method and system for providing a new user experience through expansion of a browsing area with respect to things of a real world.

According to an aspect of the present invention, there is provided a virtual object browsing method configured as a computer, the method including acquiring identification information of a captured object from the object, acquiring information about a service provider of a virtual object mapped to the identification information, and acquiring related information of the object from the corresponding service provider based on the information about the service provider.

The acquiring of the information about the service provider may include transferring, as a query, the identification information to an object name resolver on a network connected by the object, and acquiring information about the service provider from the object name resolver in response to the query.

According to another aspect of the present invention, there is provided a virtual object browsing method configured as a computer, the method including acquiring a virtual object list associated with a captured object from a service provider that provides object information about the object, and acquiring related information of the object from a service provider of each of virtual objects included in the virtual object list.

The service provider may browse a virtual object using a context associated with a user.

The acquiring of the related information of the object may include acquiring at least one of status information and control information of the object from the service provider.

According to still another aspect of the present invention, there is provided a virtual object browsing method configured as a computer, the method including acquiring service information associated with an input event of a user device, generating an object capture operation configuration for object capturing based on the service information, and capturing object information about a virtual object based on the object capture operation configuration.

The acquiring of the service information may include discovering the service information based on a result of analyzing the input event using user information recognized at the user device.

The object capture operation configuration may include at least one of a capture interval, a capture priority, and a capture method for capturing the object information.

According to still another aspect of the present invention, there is provided a virtual object browsing system including a memory in which at least one program is loaded, and at least one processor. According to a control of the at least one processor, the at least one processor is configured to process a process of acquiring identification information of a captured object from the object, a process of acquiring information about a service provider of a virtual object mapped to the identification information, and a process of acquiring related information of the object from the corresponding service provider based on the information about the service provider.

According to still another aspect of the present invention, there is provided a virtual object browsing system including a memory in which at least one program is loaded, and at least one processor. According to a control of the at least one processor, the at least one processor is configured to process a process of acquiring a virtual object list associated with a captured object from a service provider that provides object information about the object, and a process of acquiring related information of the object from a service provider of each of virtual objects included in the virtual object list.

### Effect

According to embodiments of the present invention, it is possible to browse related information based on a user's intent in a next generation web environment in which real-world information is connected to a virtual object, and to provide a new user experience through expansion of a browsing area with respect to things of a real world. Accordingly, a further effective discovery result may be provided by verifying the user's intent with respect to browsing and displaying of a virtual object.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1 and 2 illustrate a virtual object service architecture according to an embodiment of the present invention;

FIG. 3 illustrates a virtual object browsing architecture according to an embodiment of the present invention;

FIG. 4 illustrates an example of comparing a legacy web browsing process and a browsing process in Internet of Things (IoT) and Internet of Everything (IoE) environments according to an embodiment of the present invention;

FIG. 5 illustrates a detailed virtual object browsing architecture according to an embodiment of the present invention;

FIG. 6 is a flowchart illustrating an example of a virtual object browsing method according to an embodiment of the present invention;

FIG. 7 is a flowchart illustrating another example of a virtual object browsing method according to an embodiment of the present invention;

FIG. 8 is a flowchart illustrating a process of analyzing a user's intent or context for object capturing according to an embodiment of the present invention; and

FIG. 9 is a block diagram illustrating an example of a configuration of a computer system according to an embodiment of the present invention.

### DETAILED DESCRIPTION

Reference will now be made in detail to embodiments of the present invention, examples of which are illustrated in the accompanying drawings, wherein like reference numerals refer to like elements throughout. Embodiments are described below to explain the present invention by referring to the figures.

Hereinafter, embodiments of the present invention will be described with reference to the accompanying drawings.

With the appearance of Internet of Things (IoT) and Internet of Everything (IoE) environments, devices connected to a network are increasing and individual devices need to provide a service using various types of virtual objects for intelligence. In addition, with the expansion of a browsing area with respect to things of a real world, a new user experience is required.

As a varying information browsing environment, browsing of a real-world object is increasing with respect to real-world things. In addition, markup-based content representation is being evolved to a content and data publish form that is an application program interface (API)-based data exposure form.

Proposed herein is a technology for discovering related information based on a user's intent in a next generation web environment in which real-world information is connected to a virtual object. This technology is applicable to the technical fields such as a web browsing, a web service and a web platform, a web architecture, a browsing application, and a mobile device.

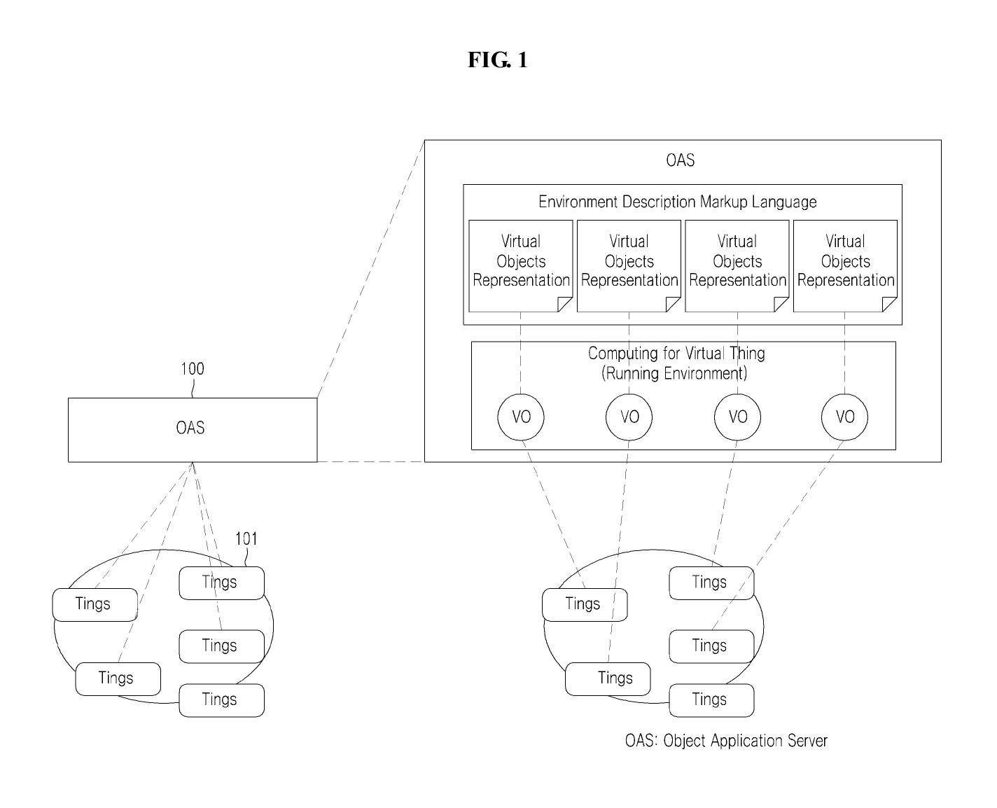

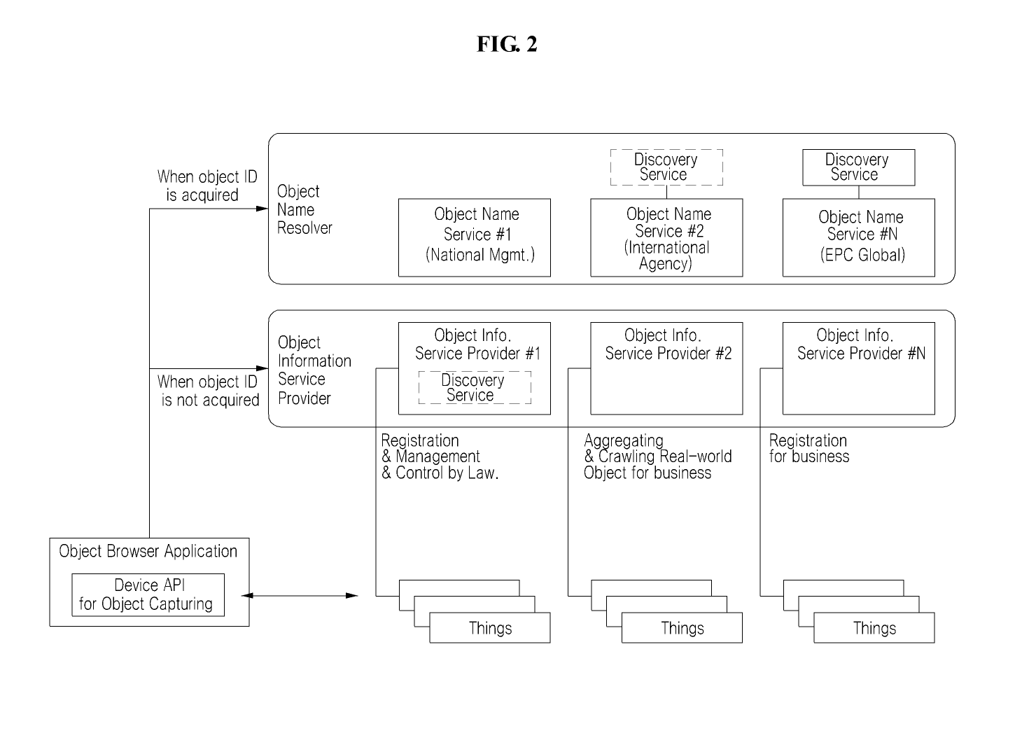

FIGS. 1 and 2 illustrate a virtual object service architecture according to an embodiment of the present invention.

FIG. 1 illustrates a service architecture between physical objects that are real-world things 101 and virtual objects (VOs).

The real-world thing 101 may indicate a smart grid system to manage energy including electricity/gas or water and sewage, a home network system to integrally manage home cooling and heating, and all the smart devices or sensors regarded as an IoT technology based service target such as a smart key capable of automatically unlocking a locking device of a vehicle door or automatically starting an engine without fixing a key to a vehicle.

Referring to FIG. 1, an object application server (OAS) 100 serves as a platform capable of controlling the real-world things 101 and may provide real-world information to the real-world things 101. For example, the OAS 100 may provide real-world information using various customized markups, such as an environment description markup language (EDML), by mapping real-world information and virtual objects.

FIG. 2 illustrates the entire architecture based on a back-end player and a service hierarch with respect to virtual objects.

Referring to FIG. 2, when an object browser application acquires an object ID for object capturing with respect to real-world things, information may be provided through an object name resolver. Conversely, when the object ID is not acquired, information may be provided through an object information service provider.

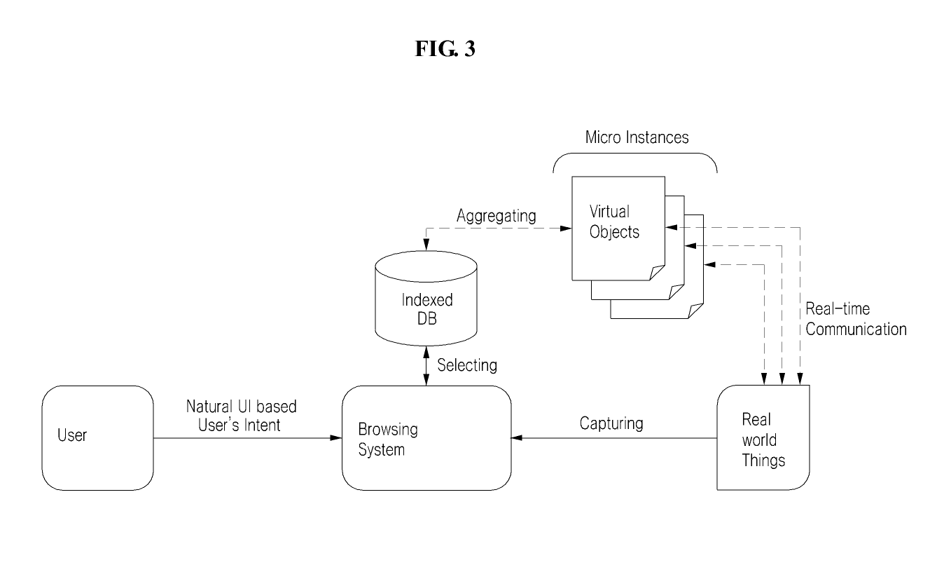

FIG. 3 illustrates a browsing architecture of a virtual object according to an embodiment of the present invention. The present embodiment proposes a browsing technology based on a user's intent as a method for browsing a virtual object in a real-world environment.

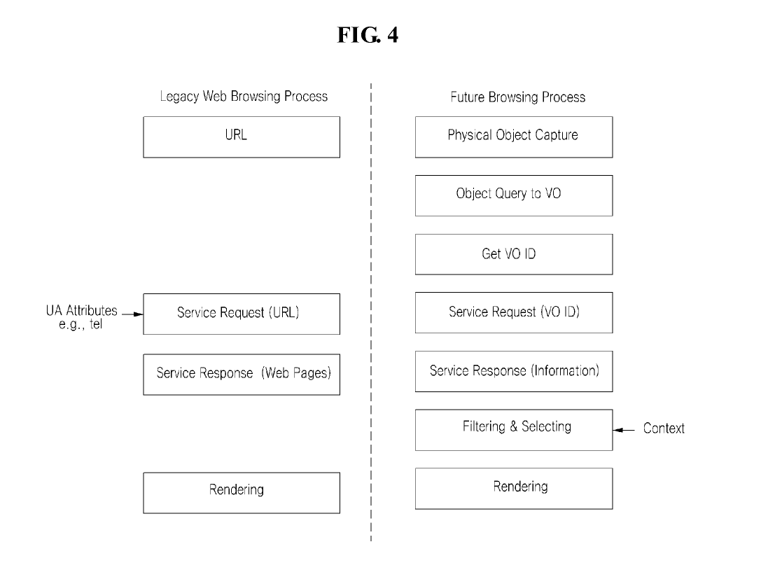

FIG. 4 illustrates an example of comparing a web-based existing browsing process, for example, a legacy web browsing process and a future browsing process in IoT and IoE environments according to an embodiment of the present invention.

Referring to FIG. 4, the existing browsing process, that is, the legacy web browsing processing may render a webpage corresponding to a uniform resource locator (URL) in response to a service request using the URL. In contrast, the future browsing process of the present invention may render a discovery result by capturing real-world information based on ID information of a virtual object.

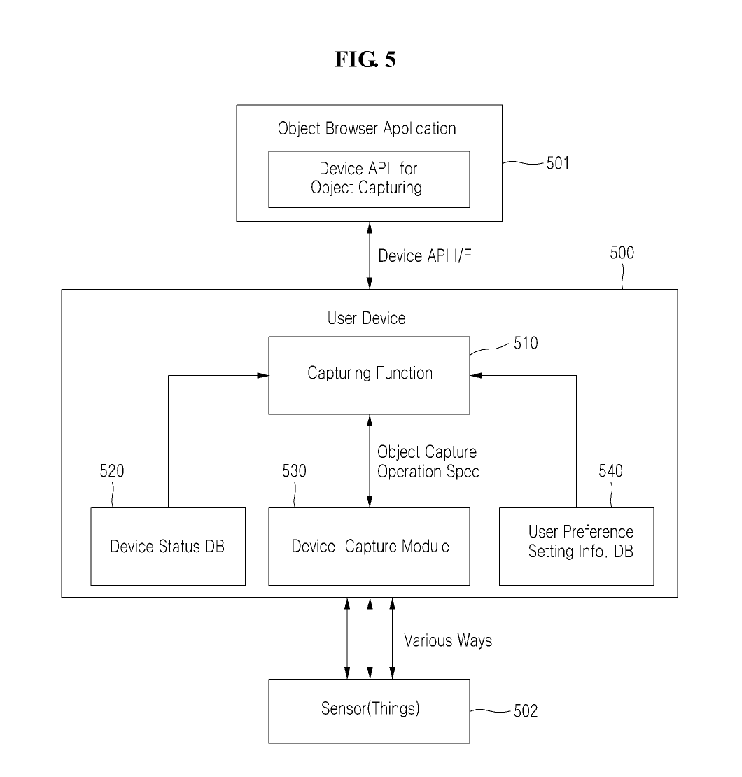

FIG. 5 illustrates a detailed virtual object browsing architecture according to an embodiment of the present invention.

Referring to FIG. 5, a virtual object browsing system according to an embodiment of the present invention may include an object browser application 501 and a user device 500.

The object browser application 501 may be connected to various devices in an application form, and needs to directly acquire information of the user device 500 and information of a sensor 502. Accordingly, a separate device API is provided.

The user device 500, as a communication device such as a smartphone, a table, and a wearable computer, may indicate any type of terminal devices capable of installing and executing an exclusive application for a virtual object capturing.

The user device 500 may include a capturing function 510 in charge of communication with the object browser application 501 and information capturing, a device status database (DB) 520 including status information of the user device 500, a device capture module 530 that is a module to interact with the available sensor 502 of the user device 500, and a user preference setting information DB 540 to store user preference information.

The device capture module 530 serves to capture real-time information periodically based on an object capture operation specification configured for object capturing.

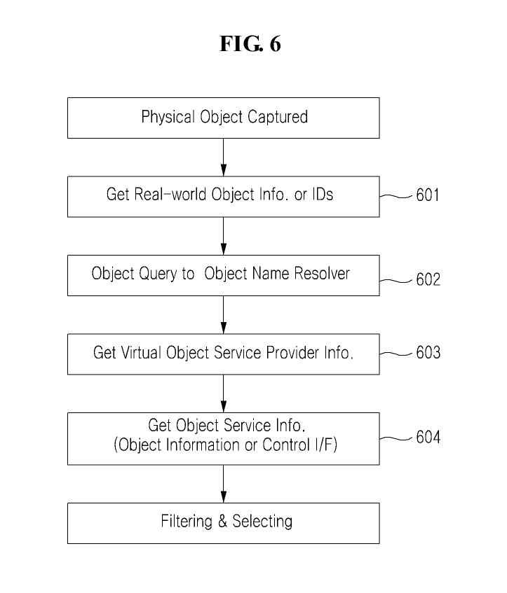

FIG. 6 is a flowchart illustrating an example of a virtual object browsing method according to an embodiment of the present invention. Operations of the virtual object browsing method according to an embodiment of the present invention may be performed by the virtual object browsing system described above with reference to FIGS. 1 through 5.

In operation 601, the virtual object browsing system may acquire ID information of a corresponding object directly from a real-time object, with respect to a physical object captured. An object capture method may use a camera, a near field communication (NFC), a radio frequency (RF), infrared (IR) rays, wireless fidelity (Wi-Fi), 3^{rd} generation (3G), and the like.

In operation 602, the virtual object browsing system may transfer ID information to an object name resolver as an object query. An object name resolver that is provided from a predetermined network provider of an object browser application or a currently belonging network provider may be used as a target of the object name resolver.

In operation 603, the virtual object browsing system may acquire virtual object service provider information mapped to ID information acquired in operation 601, from the object name resolver.

In operation 604, the virtual object browsing system may acquire object service information, such as status information of a corresponding object and control information, from an object information service provider corresponding to the service provider information acquired in operation 603.

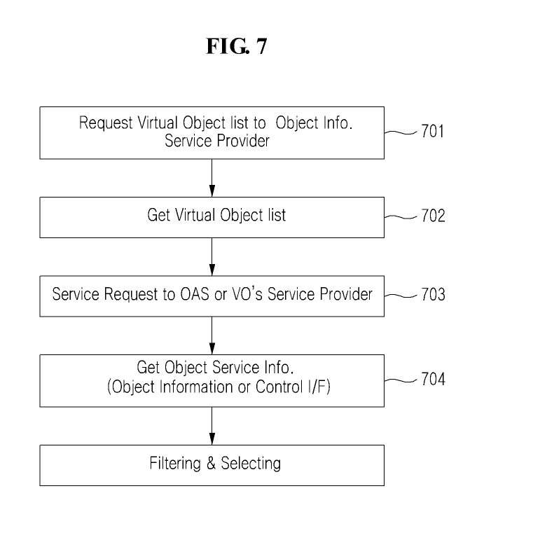

FIG. 7 is a flowchart illustrating another example of a virtual object browsing method according to an embodiment of the present invention. Operations of the virtual object browsing method according to an embodiment of the present invention may be performed by the virtual object browsing system described above with reference to FIGS. 1 through 5.

In operation 701, the virtual object browsing system may request an object information service provider for a virtual object list when ID information is not acquired from a real-world thing. That is, the virtual object browsing system may request the object information service provider for virtual object information based on a user context.

Accordingly, the object information service provider may discover context-based object information using a discovery service function. In operation 702, the virtual object browsing system may acquire the virtual object list from the object information service provider.

In operation 703, the virtual object browsing system may request an object application server (OAS) or the object information service provider for individual information with respect to each of objects included in the virtual object list.

In operation 704, the virtual object browsing system may acquire object service information, such as status information and control information, for each object from the object application server or the object information service provider.

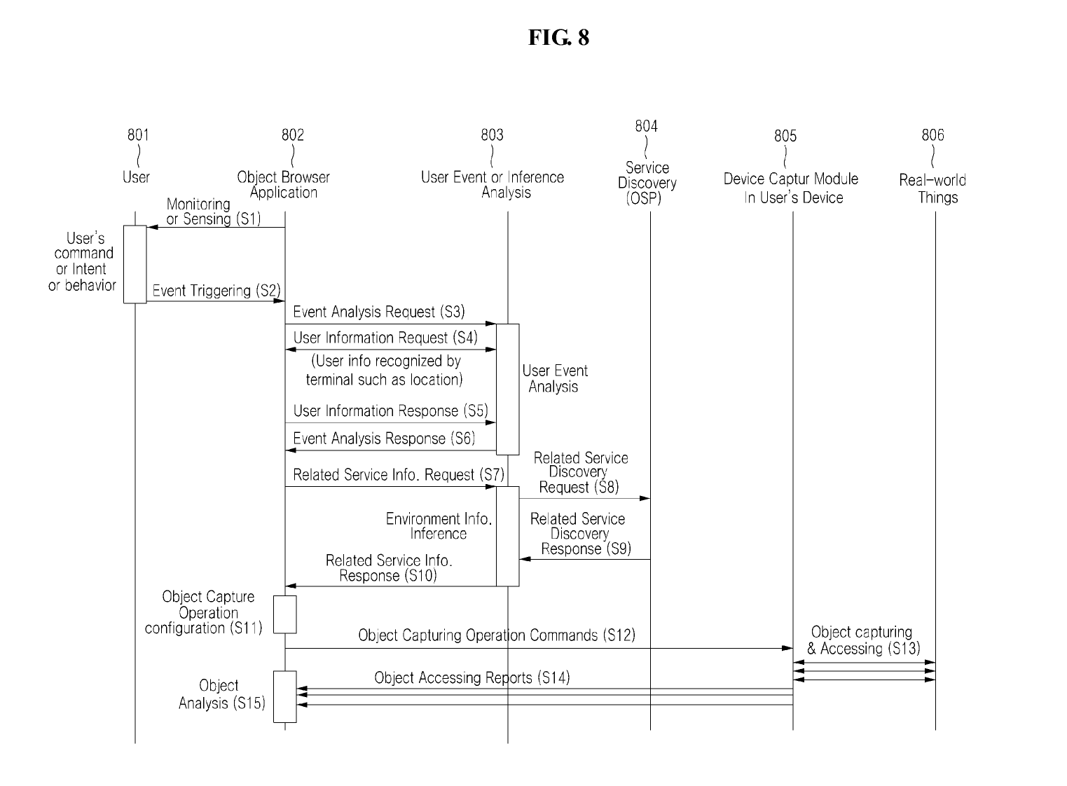

FIG. 8 is a flowchart illustrating a process of analyzing a user's intent or context for object capturing according to an embodiment of the present invention.

Through monitoring or sensing for a user device 801 in operation S1, an object browser application 802 may trigger an event associated with a user's command, intent, or behavior in operation S2.

In operation S3, the object browser application 802 may request a user event or interference analysis 803 to analyze the corresponding event.

In operation S4, the user event or interference analysis 803 may request the object browser application 802 for user information in response to the event analysis request. Here, user information may indicate information recognized by a device, such as location and preference information.

In operation S5, the object browser application 802 may provide user information requested by the user event or interference analysis 803.

In operation S6, the user event or interference analysis 803 may provide an event analysis result to the object browser application 802.

In operation S7, the object browser application 802 may request the user event or interference analysis 803 for related service information based on the event analysis result.

In operation S8, the user event or interference analysis 803 may request a service discovery, that is, an object information service provider (OSP), 804 for discovery of service information requested by the object browser application 802.

In operation S9, the service discovery 804 may discover service information requested by the object browser application 802 and may provide the discovery result to the user event or interference analysis 803.

In operation S10, the user event or interference analysis 803 may provide the object browser application 802 with related service information received from the search discovery 804.

In operation S11, the object browser application 802 may configure an object capture operation based on related service information according to the event analysis result.

In operation S12, the object browser application 802 may transfer a command for an object capture operation to a device capture module 805 of a user device based on the configuration of operation S11.

The device capture module 805 may perform object capturing and accessing with respect to real-world things 806 in operation S13, and may transfer, to the object browser application 802, reports according to the object capturing and accessing in operation S14.

In operation S15, the object browser application 802 may analyze objects of the real world based on the reports transferred from the device capture module 805.

In the present embodiment, an object capture operation configuration may include a capture interval, a capture priority, a capture method such as a camera, an NFC, an RF, IR, Wi-Fi, and 3G, and information regarding whether to use sensor data correction information such as sensor data fusion. Here, when a sensor data fusion function is provided at a hardware level, controllable information such as an information processing priority for each hardware and an information processing sensitivity may be used.

Information corresponding to the object capture operation configuration may be utilized for any type of devices capable of verifying user information such as a qualified-self product, as well as a mobile device.

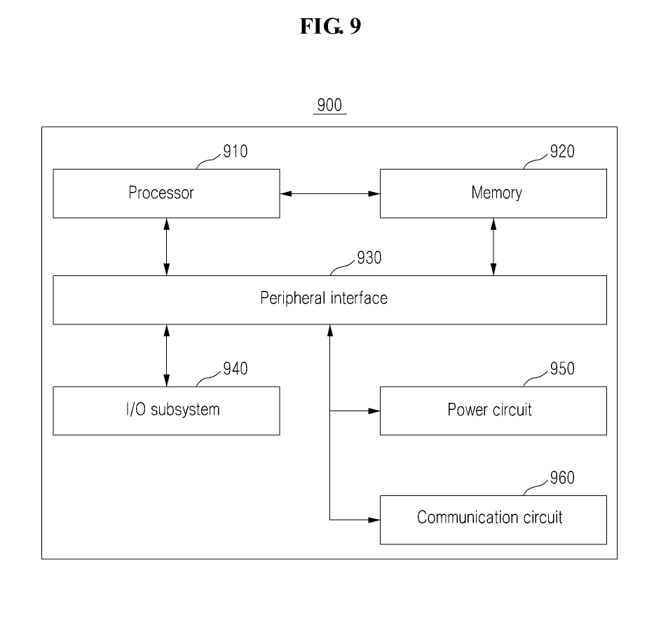

FIG. 9 is a block diagram illustrating an example of a configuration of a computer system 900 according to an embodiment of the present invention. The computer system 900 may include at least one processor 910, a memory 920, a peripheral interface 930, an I/O subsystem 940, a power circuit 950, and a communication circuit 960. Here, the computer system 900 may correspond to a device for virtual object browsing.

The memory 920 may include, for example, a high-speed random access memory (HSRAM), a magnetic disk, a static random access memory (SRAM), a dynamic RAM (SRAM), read only memory (ROM), a flash memory, and a non-volatile memory. The memory 920 may include a software module, an instruction set, or a variety of data required for an operation of the computer system 900. Here, an access from another component such as the processor 910 and the peripheral interface 930 to the memory 920 may be controlled by the processor 910.

The peripheral interface 930 may couple an input device and/or output device of the computer system 900 with the processor 910 and the memory 920. The processor 910 may perform a variety of functions for the computer system 900 and process data by executing the software module or the instruction set stored in the memory 920.

The I/O subsystem 940 may couple various I/O peripheral devices with the peripheral interface 930. For example, the I/O subsystem 940 may include a controller for coupling the peripheral interface 930 and a peripheral device such as a monitor, a keyboard, a mouse, a printer, and a touch screen or a sensor depending on a necessity. The I/O peripheral devices may be coupled with the peripheral interface 930 without using the I/O subsystem 940.

The power circuit 950 may supply a power to all of or a portion of components of a terminal. For example, the power circuit 950 may include a power management system, at least one power source such as a battery and alternating circuit (AC), a charge system, a power failure detection circuit, a power converter or inverter, a power status indicator, or other components for generating, managing and distributing power.

The communication circuit 960 enables communication with another computer system using at least one external port. Alternatively, as described above, the communication circuit 960 may enable communication with another computer system by including an RF circuit and thereby transmitting and receiving an RF signal known as an electromagnetic signal.

The embodiment of FIG. 9 is only an example of the computer system 900. The computer system 900 may have a configuration or an arrangement for omitting a portion of the components illustrated in FIG. 9, further including components not illustrated in FIG. 9, or coupling two or more components. For example, a computer system for a communication terminal of a mobile environment may further include a touch screen, a sensor, and the like, in addition to the components of FIG. 9. A circuit for RF communication using a variety of communication methods, for example, Wi-Fi, 3G, long term evolution (LTE), Bluetooth, NFC, and ZigBee may be included in the communication circuit 960. Components includable in the computer system 900 may be configured as hardware that includes an integrated circuit specified for at least one signal processing or application, software, or a combination of hardware and software.

The aforementioned object browsing method may include a further reduced number of operations or additional operations based on the description related to the virtual object browsing system made above with reference to FIGS. 1 through 8. Also, at least two operations may be combined and orders or locations of the operations may be changed.

As described above, according to embodiments of the present invention, it is possible to discover related information based on a user's intent in a next generation web environment in which real-world information is connected to a virtual object and to provide a new user experience through expansion of a browsing area targeted with respect to things of a real world. Accordingly, a further effective discovery result may be provided by verifying the user's intent at the event of browsing and displaying a virtual object.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described example embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments of the present invention, or vice versa.

Although a few example embodiments of the present invention have been shown and described, the present invention is not limited to the described example embodiments. Instead, it would be appreciated by those skilled in the art that changes may be made to these example embodiments without departing from the principles and spirit of the invention, the scope of which is defined by the claims and their equivalents.

What is claimed is:

1. A virtual object browsing method configured as a computer, the method comprising:
acquiring identification information of a captured object from the object;
acquiring information about a service provider of a virtual object mapped to the identification information; and
acquiring related information of the object from the corresponding service provider based on the information about the service provider.

2. The method of claim 1, wherein the acquiring of the information about the service provider comprises:
transferring, as a query, the identification information to an object name resolver on a network connected by the object; and
acquiring information about the service provider from the object name resolver in response to the query.

3. A virtual object browsing method configured as a computer, the method comprising:
acquiring a virtual object list associated with a captured object from a service provider that provides object information about the object; and
acquiring related information of the object from a service provider of each of virtual objects included in the virtual object list.

4. The method of claim 3, wherein the service provider browses a virtual object using a context associated with a user.

5. The method of claim 3, wherein the acquiring of the related information of the object comprises acquiring at least one of status information and control information of the object from the service provider.

6. A virtual object browsing method configured as a computer, the method comprising:
acquiring service information associated with an input event of a user device;
generating an object capture operation configuration for object capturing based on the service information; and
capturing object information about a virtual object based on the object capture operation configuration.

7. The method of claim 6, wherein the acquiring of the service information comprises discovering the service information based on a result of analyzing the input event using user information recognized at the user device.

8. The method of claim 6, wherein the object capture operation configuration comprises at least one of a capture interval, a capture priority, and a capture method for capturing the object information.

9. A virtual object browsing system comprising:
a memory in which at least one program is loaded; and
at least one processor,
wherein, according to a control of the at least one processor, the at least one processor is configured to process:
a process of acquiring identification information of a captured object from the object;
a process of acquiring information about a service provider of a virtual object mapped to the identification information; and
a process of acquiring related information of the object from the corresponding service provider based on the information about the service provider.

10. The virtual object browsing system of claim 9, wherein the process of acquiring information about the service provider transfers, as a query, the identification information to an object name resolver on a network connected by the object, and acquires information about the service provider from the object name resolver in response to the query.

11. A virtual object browsing system comprising:
a memory in which at least one program is loaded; and
at least one processor,
wherein, according to a control of the at least one processor, the at least one processor is configured to process:
a process of acquiring a virtual object list associated with a captured object from a service provider that provides object information about the object; and
a process of acquiring related information of the object from a service provider of each of virtual objects included in the virtual object list.

12. The virtual object browsing system of claim 11, wherein the service provider browses a virtual object using a context associated with a user.

13. The virtual object browsing system of claim 11, wherein the process of acquiring related information of the object acquires at least one of status information and control information of the object from the service provider.

14. The virtual object browsing system of claim 11, wherein the at least one processor is configured to generate an object capture operation configuration based on service information associated with an input event of a user and to perform a capture function about the virtual object based on the object capture operation configuration.

15. The virtual object browsing system of claim 14, wherein the object capture operation configuration comprises at least one of a capture interval, a capture priority, and a capture method for capturing the object information.
